(19) United States
(12) Patent Application Publication
(10) Pub. No.: US 2026/0241340 A1
(43) Pub. Date: Aug. 20, 2026

(54) COOLING TOWER, CARBON DIOXIDE CAPTURE DEVICE, AND METHOD FOR TREATING SURFACE OF PACKING

(71) Applicant: MITSUBISHI HEAVY INDUSTRIES, LTD., Tokyo (JP)

(72) Inventors: Miku Iwamoto, Tokyo (JP); Tetsu Ushiku, Tokyo (JP); Osamu Miyamoto, Tokyo (JP); Tatsuya Tsujiuchi, Tokyo (JP); Kendall Fruchey, Humble, TX (US); Justin Federici, Doylestown, PA (US); Michael Hergenrother, Kingwood, TX (US)

(73) Assignee: MITSUBISHI HEAVY INDUSTRIES, LTD., Tokyo (JP)

(21) Appl. No.: 19/055,636

(22) Filed: Feb. 18, 2025

(51) Int. Cl. B01D 53/92; B01D 53/14; B01D 53/18; B01D 53/50

(52) U.S. Cl. CPC B01D 53/92; B01D 53/1425; B01D 53/1475; B01D 53/185; B01D 53/504; B01D 2257/504

(57) ABSTRACT

A cooling tower that cools exhaust gas includes a main body portion inside which the exhaust gas can flow, a packing that is provided inside the main body portion and cools the exhaust gas flowing through the main body portion, a circulation unit that includes a circulation flow passage through which cooling water stored in a lower part of the main body portion is pumped up and circulated to an upper part of the main body portion, a liquid dispersing unit that is connected to the circulation flow passage at the upper part of the main body portion and supplies the cooling water to the packing from above the packing, and a supply unit that supplies a surface roughening material for roughening a surface of the packing to the inside of the main body portion.

### BACKGROUND OF THE INVENTION

### Field of the Invention

The present disclosure relates to a cooling tower, a carbon dioxide capture device, and a method for treating a surface of a packing.

### Description of Related Art

A carbon dioxide capture device that removes and captures carbon dioxide from exhaust gas includes a cooling tower that cools the exhaust gas, an absorption tower that absorbs the carbon dioxide contained in the cooled exhaust gas into an absorbent liquid for capture, and a regeneration tower that separates the carbon dioxide from the absorbent liquid that has absorbed the carbon dioxide and regenerates the absorbent liquid. The absorption tower is provided with a gas-liquid contact plate and a nozzle for spraying the absorbent liquid onto the gas-liquid contact plate inside thereof. The absorption efficiency of carbon dioxide depends on a contact area between the exhaust gas and the absorbent liquid. Therefore, in order to enhance the absorption efficiency, it is desirable to use a material with high surface wettability and easy spreading of the absorbent liquid for the gas-liquid contact plate. In the related art, a metal material with good wettability to an aqueous solution has been used as the material of the gas-liquid contact plate. In addition, Patent Document 1 describes that a process of roughening a surface of a metal gas-liquid contact plate (such as blasting) is performed to improve wettability of the gas-liquid contact plate.

Since the metal gas-liquid contact plate is heavy, a structure that supports the gas-liquid contact plate becomes larger. In this regard, it is considered to use a resin material, which is lighter than the metal material, for the gas-liquid contact plate. In general, resins are hydrophobic. For this reason, Patent Document 2 discloses a method of performing a surface treatment to enhance wettability on a resin gas-liquid contact plate and then installing the gas-liquid contact plate in a tower.

Patent Document 1 Japanese Patent No. 7047273

Patent Document 2 United States Patent No. 5794775

### SUMMARY OF THE INVENTION

The cooling tower of the carbon dioxide capture device is provided with a packing inside, and the exhaust gas is cooled by coming into gas-liquid contact with cooling water dispersed onto the packing. For the cooling tower as well, the larger the contact area between the exhaust gas and the cooling water is, that is, the higher the wettability of the packing is, the greater the cooling efficiency that can be achieved is. However, in the related art, an additional process of performing the surface treatment for the packing is required before installing the cooling tower. Additionally, in a case where the wettability has decreased during an operation, it is necessary to stop the operation and replace the packing.

The present disclosure provides a carbon dioxide capture device and a method for treating a surface of a packing that can perform a surface treatment to enhance wettability of a packing after installation in a cooling tower.

According to one aspect of the present disclosure, there is provided a cooling tower that cools exhaust gas, including: a packing configured to cool the exhaust gas flowing inside the cooling tower; a circulation unit including a circulation flow passage through which cooling water stored in a lower part of the cooling tower is pumped up by a pump and circulated to an upper part of the cooling tower, and a heat exchanger configured to cool the cooling water flowing through the circulation flow passage; a liquid dispersing unit connected to the circulation flow passage at the upper part of the cooling tower and configured to supply the cooling water to the packing from above the packing; and a supply unit configured to supply a surface roughening material for roughening a surface of the packing to the inside of the cooling tower.

According to one aspect of the present disclosure, there is provided a carbon dioxide capture device including: the cooling tower mentioned above; an absorption tower configured to absorb carbon dioxide contained in the exhaust gas cooled by the cooling tower into an absorbent liquid for removal; and a regeneration tower configured to regenerate the absorbent liquid by separating the carbon dioxide from the absorbent liquid discharged from the absorption tower.

According to one aspect of the present disclosure, there is provided a method for treating a surface of a packing of a cooling tower that cools exhaust gas, the method including: a step of cooling the exhaust gas flowing inside the cooling tower, via a packing; a step of pumping up cooling water stored in a lower part of the cooling tower using a pump and circulating the cooling water to an upper part of the cooling tower through the circulation flow passage, and cooling the cooling water flowing through the circulation flow passage, via a heat exchanger; a step of supplying the cooling water to the packing from above the packing, via a liquid dispersing unit connected to the circulation flow passage at the upper part of the cooling tower; and a step of supplying a surface roughening material for roughening a surface of the packing to the inside of the cooling tower.

According to the above-mentioned aspects, it is possible to perform a surface treatment to enhance wettability of a packing after installation in a cooling tower.

### BRIEF DESCRIPTION OF THE DRAWINGS

FIG. 1 is a schematic diagram showing the overall configuration of a carbon dioxide capture system according to a first embodiment of the present disclosure.

FIG. 2 is a schematic diagram showing the configuration of a cooling tower

according to the first embodiment of the present disclosure.

FIG. 3 is a first flowchart showing an example of a surface treatment according

to the first embodiment of the present disclosure.

FIG. 4 is a second flowchart showing an example of the surface treatment

according to the first embodiment of the present disclosure.

FIG. 5 is a schematic diagram showing the configuration of a cooling tower

according to a second embodiment of the present disclosure.

FIG. 6 is a schematic diagram showing the configuration of a cooling tower according to a third embodiment of the present disclosure.

FIG. 7 is a schematic block diagram showing the configuration of a computer of

a control unit according to at least one embodiment.

### DETAILED DESCRIPTION OF THE INVENTION

### First Embodiment

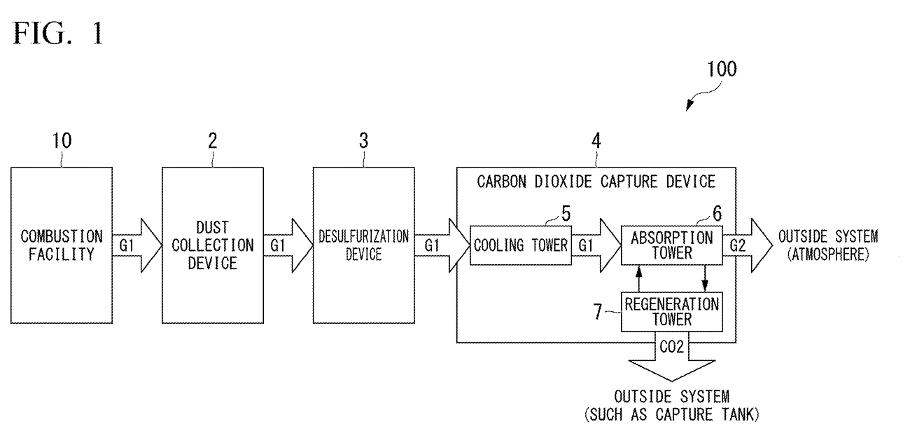

Hereinafter, a carbon dioxide capture system according to a first embodiment of the present disclosure will be described in detail with reference to FIGS. 1 to 4.

### Overall Configuration of Carbon Dioxide Capture System

FIG. 1 is a schematic diagram showing an overall configuration of the carbon dioxide capture system according to the first embodiment of the present disclosure. A carbon dioxide capture system 100 captures carbon dioxide from exhaust gas G1 discharged from a combustion facility 10. The combustion facility 10 burns fuel and air to discharge the exhaust gas G1 and may be, for example, any type of facility such as a boiler, an incinerator, or a gas turbine. The carbon dioxide capture system 100 includes a dust collection device 2, a desulfurization device 3, and a carbon dioxide capture device 4. The dust collection device 2 and the desulfurization device 3 need only be installed as necessary depending on the properties of the exhaust gas G1 and can be omitted. That is, the configuration of the carbon dioxide capture system 100 may be changed depending on the combustion facility 10.

The dust collection device 2 is provided downstream of the combustion facility 10. The dust collection device 2 removes soot and the like contained in the exhaust gas G1. The dust collection device 2 is, for example, a dry-type electrostatic precipitator (ESP) or a bag filter.

The desulfurization device 3 is provided downstream of the dust collection device 2. The desulfurization device 3 removes sulfur oxides (SOx) contained in the exhaust gas G1.

The carbon dioxide capture device 4 is provided downstream of the desulfurization device 3. The carbon dioxide capture device 4 includes a cooling tower 5, an absorption tower 6, and a regeneration tower 7. The cooling tower 5 cools the exhaust gas G1. The absorption tower 6 absorbs carbon dioxide contained in the exhaust gas G1 cooled by the cooling tower 5 into an absorbent liquid for removal. The absorption tower 6 discharges purified gas G2, after removing carbon dioxide, to an outside of the system (atmosphere) and discharges the absorbent liquid, which has absorbed the carbon dioxide, to the regeneration tower 7. The regeneration tower 7 separates carbon dioxide from the absorbent liquid discharged by the absorption tower 6 and regenerates the absorbent liquid. The regeneration tower 7 returns the regenerated absorbent liquid to the absorption tower 6 and discharges the separated carbon dioxide to the outside of the system. The carbon dioxide discharged from the regeneration tower 7 is stored in a capture tank or the like and used in another system or the like.

### Configuration of Cooling Tower

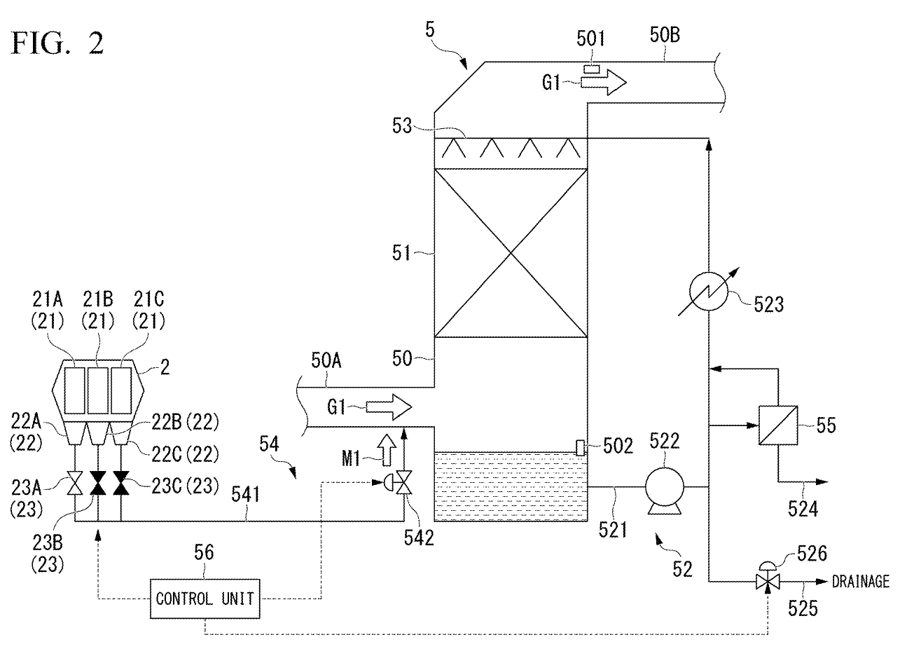

FIG. 2 is a schematic diagram showing a configuration of the cooling tower according to the first embodiment of the present disclosure. As shown in FIG. 2, the cooling tower 5 includes a main body portion 50, a packing 51, a circulation unit 52, a liquid dispersing unit 53, a supply unit 54, a capture unit 55, and a control unit 56.

The main body portion 50 is a hollow container extending in a vertical direction, inside which the exhaust gas G1 flows in the vertical direction. An exhaust gas introduction flow passage 50A through which the exhaust gas G1, which has been treated by the dust collection device 2 and the desulfurization device 3, is introduced into the inside of the main body portion 50 is connected to a lower part of the main body portion 50 (to an upstream side in a flow direction of the exhaust gas G1). An exhaust gas discharge flow passage SOB through which the exhaust gas G1, which has been cooled inside the main body portion 50, is discharged to the absorption tower 6 is connected to an upper part of the main body portion 50 (to a downstream side in the flow direction of the exhaust gas G1). A blower (not shown) is provided between the cooling tower 5 and the absorption tower 6 (on the downstream side of the exhaust gas discharge flow passage SOB), and the exhaust gas is drawn into the absorption tower 6 by the blower. Cooling water of the exhaust gas G1 is stored in the lower part of the main body portion 50. The cooling water is condensed water generated by cooling moisture contained in the exhaust gas G1. When the exhaust gas G1 is not introduced, such as during the trial operation of the cooling tower 5, water introduced from the outside may be used as the cooling water. In addition, the main body portion 50 is provided with sensors such as a temperature sensor 501 that measures a temperature of the exhaust gas G1 discharged from the main body portion 50 and a liquid level sensor 502 that measures a liquid level height of the cooling water.

The packing 51 is provided inside the main body portion 50. The packing 51 is formed of, for example, a resin material.

The circulation unit 52 pumps up the cooling water stored in the lower part of the main body portion 50 using a pump 522 and circulates the cooling water as the cooling water to the upper part of the main body portion 50 through a circulation flow passage 521. The circulation flow passage 521 is provided with a heat exchanger 523 that cools the cooling water pumped up by the pump 522. The lower side of the circulation flow passage 521 is the upstream side in the flow direction of the cooling water, and the upper side is the downstream side of the cooling water in the flow direction. Additionally, the circulation unit 52 monitors a measured value of the liquid level sensor 502, and in a case where an amount of the cooling water stored in the main body portion 50 exceeds a certain amount, the circulation unit 52 adjusts an opening degree of a control valve 526 under the control of the control unit 56 to drain a part of the cooling water flowing through the circulation flow passage 521 via a drainage flow passage 525. In FIG. 2, an example is shown in which the drainage flow passage 525 branches from the circulation flow passage 521 on the upstream side of the capture unit 55, which will be described below, but the drainage flow passage 525 may branch from the circulation flow passage 521 on the downstream side of the capture unit 55 (on the upstream side of the heat exchanger 523).

The liquid dispersing unit 53 is connected to an outlet of the circulation flow passage 521 at the upper part of the main body portion 50. The liquid dispersing unit 53 is disposed above the packing 51 and supplies the cooling water cooled by the circulation unit 52 to the packing 51. Consequently, the cooling water supplied from the liquid dispersing unit 53 flows from an upper part to a lower part of the packing 51. The exhaust gas G1 flowing from the lower part to the upper part of the main body portion 50 is cooled by coming into gas-liquid contact with the cooling water flowing through the packing 51. The liquid dispersing unit 53 may be any type of liquid disperser such as a spray-type liquid disperser, a trough-type liquid disperser, a channel-type liquid disperser, an element-type liquid disperser, or a tubular-type liquid disperser.

The supply unit 54 supplies a surface roughening material for roughening a surface of the packing 51 to the inside of the main body portion 50. In the present embodiment, a powder M1 is used as the surface roughening material. For example, the soot collected by the dust collection device 2 (particulate materials including coal ash and the like) is reused as the powder M1. Instead of the soot collected by the dust collection device 2, purchased particulate materials such as limestone, mica, quartz, or silicon dioxide may be used as the powder M1.

The supply unit 54 includes a supply line 541 and a control valve 542. The supply line 541 may be connected to the vicinity of a connecting portion of the exhaust gas introduction flow passage SOA to the main body portion 50 as in the example of FIG. 2 or may be directly connected to the main body portion 50. The control valve 542 opens and closes in accordance with the control of the control unit 56 to start or stop supplying the powder ML. In addition, the control valve 542 can increase or decrease a supply amount of the powder M1 by changing the opening degree in accordance with the control of the control unit 56.

The powder M1 flows into the lower part of the main body portion 50 together with the exhaust gas G1 through the supply line 541. As described above, the exhaust gas G1 discharged from the cooling tower 5 is drawn into the absorption tower 6 by the blower (not shown) provided between the cooling tower 5 and the absorption tower 6. Therefore, since the inside of the main body portion 50 of the cooling tower 5 is at a lower pressure than the supply line 541, which is atmospheric pressure, the supply unit 54 injects the powder M1 from the supply line 541 to the inside of the main body portion 50 by using this pressure difference.

The powder M1 that has flowed into the main body portion 50 flows upward inside the main body portion 50 together with the exhaust gas G1 and adheres to the surface of the packing 51. The powder M1 adhering to the packing 51 is mixed with the cooling water supplied from the liquid dispersing unit 53 to form a slurry. The slurry flows over the surface of the packing 51 to roughen (grind) the surface of the packing 51, thereby performing surface roughening. Alternatively, the powder M1 adheres to the surface of the packing 51 to roughen the surface of the packing 51. In a case where the surface of the packing 51 is roughened, wettability is improved, and cooling capacity increases.

The capture unit 55 filters the cooling water flowing through the circulation flow passage 521 and captures the powder M1 from the cooling water. The capture unit 55 is a filter system with an automatic backwashing function or an auto-strainer. The capture unit 55 of the present embodiment is provided in a branch flow passage 524 branching from the circulation flow passage 521 and filters the cooling water flowing through the circulation flow passage 521. Additionally, the cooling water that has been filtered by the capture unit 55 (cooling water not containing the powder M1) is discharged to the outside of the system through the branch flow passage 524. On the other hand, the cooling water containing the powder M1 is returned to the circulation flow passage 521 and reused for the treatment to roughen the surface of the packing 51 by being supplied by the liquid dispersing unit 53. The filter in the capture unit 55 may be designed with a filter material to adjust the particle size of the captured powder M1. That is, it is also possible to select a filter material that allows the powder M1 with a certain particle size or smaller to pass through, as the filter material of the capture unit 55. In this manner, since the powder M1 with a particle size that contributes less to improve the surface roughness of the packing is discharged from the branch flow passage 524 to the outside of the system, the impact of the powder M1 on the pump 522 and the heat exchanger 523 can be further suppressed.

The control unit 56 controls the surface treatment of the packing 51. The control unit 56 performs the surface treatment to roughen the surface of the packing 51 by controlling the control valve 542 of the supply unit 54 to allow the powder M1 to flow into the inside of the main body portion 50 during the trial operation before the start of a normal operation of the cooling tower 5. In addition, the control unit 56 may further perform the surface treatment of the packing 51 by controlling the control valve 542 of the supply unit 54, as necessary, to allow the powder M1 to flow into the inside of the main body portion 50 during the normal operation of the cooling tower 5.

As in the example of FIG. 2, in a case where the dust collection device 2 includes a plurality of dust collection units 21, and the dust collection units 21 can collect powders M1 (soot) of different particle sizes, a powder M1 of an appropriate particle size may be selected according to the material of the packing 51 and the like and supplied to the main body portion 50. For example, the dust collection unit 21 includes dust collection units 21A, 21B, and 21C in order from the upstream side in the flow direction of the exhaust gas G1. The dust collection unit 21A on the upstream side collects the powder M1 of a larger particle size. The soot collected by the dust collection units 21A, 21B, and 21C is shaken off and accumulated in corresponding hoppers 22A, 22B, and 22C. That is, the powders M1 of different particle sizes are accumulated in the hoppers 22A, 22B, and 22C. The supply line 541 of the supply unit 54 is connected to the hopper 22 in which the powder M1 of the selected particle size is accumulated. For example, in order to roughen the surface of the packing 51, it may be more effective to use the powder M1 of a larger particle size. In this case, the supply line 541 is connected to the hopper 22A on the most upstream side, in which the powder M1 of a larger particle size is accumulated. Additionally, depending on the material of the packing 51, it may be more effective to use the powder M1 of a smaller particle size. In this case, the supply line 541 is connected to the hopper 22B or 22C on the downstream side, in which the powder M1 of a smaller particle size is accumulated.

In addition, as in the example of FIG. 2, the supply line 541 may be connected to the hoppers 22A, 22B, and 22C via on-off valves 23A, 23B, and 23C, and the control unit 56 may switch the open/closed state of the on-off valve 23 to allow the powder M1 of any particle size to be selected. In the example of FIG. 2, the control unit 56 opens the on-off valve 23A on the most upstream side and closes the other on-off valves 23B and 23C such that the powder M1 of a larger particle size is used. The configuration of FIG. 2 is an example, and the number of the dust collection unit 21, the hopper 22, and the on-off valve 23 provided in the dust collection device 2 may be freely changed.

### Surface Treatment 1 of Packing

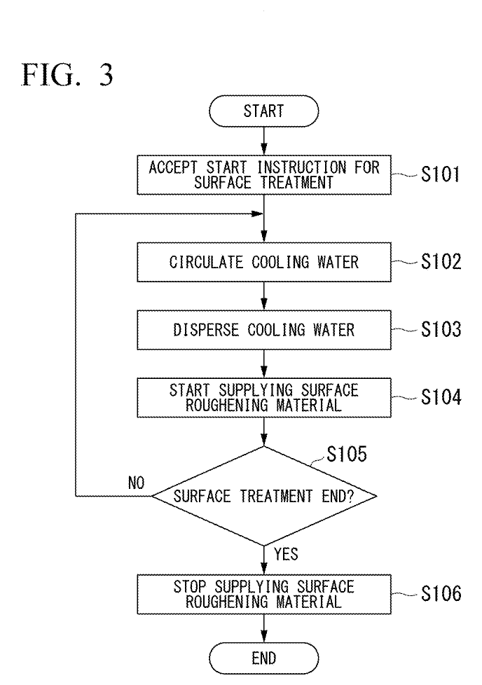

FIG. 3 is a first flowchart showing an example of the surface treatment according to the first embodiment of the present disclosure. Here, a method of performing the surface treatment of the packing 51 via the control unit 56 before the start of the normal operation of the cooling tower 5 will be described. For example, the control unit 56 performs the surface treatment shown in FIG. 3 during the trial operation when the cooling tower 5 is newly installed or during the trial operation for maintenance of the cooling tower 5 in operation. Since the combustion facility 10 may not be operated during the trial operation, cooling water is supplied from the outside to the cooling tower 5. During the trial operation when the cooling tower 5 is newly installed, soot (powder M1) may not be collected by the dust collection device 2. In that case, soot captured from another dust collection device or particulate materials such as purchased limestone are used as the powder M1. During the trial operation for maintenance, soot collected by the dust collection device 2 before the maintenance may be used as the powder M1.

First, the control unit 56 accepts a start instruction for the surface treatment (step S101). For example, the control unit 56 accepts an input operation of the start instruction from an operator performing the installation or maintenance of the carbon dioxide capture device 4.

Upon accepting the start instruction for the surface treatment, the control unit 56 causes the circulation unit 52 to circulate the cooling water by operating the pump 522 (step S 102) and causes the liquid dispersing unit 53 to supply the cooling water pumped up by the pump 522 to the main body portion 50 (step S 103). Then, the control unit 56 performs control of bringing the control valve 542 of the supply unit 54 into an open state and starts supplying the powder M1 to the main body portion 50 (step S104). In this case, the control unit 56 controls the opening degree of the control valve 542 according to the material of the packing 51 and the like and adjusts the supply amount of the powder M1. In this case, it is desirable that the control unit 56 adjusts the supply amount of the powder M1 such that the supply amount does not exceed the allowable range of the pump 522.

The powder M1 is drawn into the inside of the main body portion 50 due to the pressure difference generated by the blower (not shown) and adheres to the surface of the packing 51. The powder M1 adhering to the packing 51 is mixed with the cooling water supplied from the liquid dispersing unit 53 to form the slurry. The slurry flows over the surface of the packing 51 to roughen (grind) the surface of the packing 51, thereby performing surface roughening. Alternatively, the powder M1 adheres to the surface of the packing 51 to roughen the surface of the packing 51. Additionally, after the start of the supply of the powder M1, the powder M1 contained in the cooling water stored at the lower part of the main body portion 50 is filtered by the capture unit 55. The filtered cooling water not containing the powder M1 is drained from the branch flow passage 524, and the cooling water containing the powder M1 is returned to the circulation flow passage 521. The cooling water containing the powder M1, which has been returned to the circulation flow passage 521, is supplied to the main body portion 50 by the liquid dispersing unit 53 and is reused for roughening of the packing 51.

Next, the control unit 56 determines whether the surface treatment of the packing 51 has ended (step S 105). For example, the control unit 56 determines that the surface treatment has ended in a case where the time taken for the trial operation while supplying the powder M1 is equal to or longer than a predetermined processing time. The processing time is set by measuring the time required for roughening through a prior test, simulation, or the like. Different processing times may be set for each combination of parameters such as the materials of the packing 51 and the powder M1 and the flow rate of the powder M1. In addition, the control unit 56 may accept the designation of the processing time from the operator in step S101. Alternatively, the control unit 56 may determine that the surface treatment has ended in a case where an input operation of an end instruction for the surface treatment from the operator is accepted.

When the control unit 56 determines that the surface treatment has not ended (step S105; NO), the control unit 56 returns to step S102 and continues the surface treatment. On the other hand, when the control unit 56 determines that the surface treatment has ended (step S105; YES), the control unit 56 performs control of bringing the control valve 542 of the supply unit 54 into a closed state and stops supplying the powder M1 to the main body portion 50 (step S 106). In this case, in a case where the trial operation may end, the circulation and supply of the cooling water are also stopped. After that, the cooling water and the powder M1 supplied to the main body portion 50 are discharged to the outside of the system from the drainage flow passage 525 when the control unit 56 opens the control valve 526.

As described above, by performing the trial operation while supplying the powder M1 after newly installing the cooling tower 5 or during the maintenance of the cooling tower 5, the surface treatment (roughening) of the packing 51 can be performed in a state in which the packing 51 remains attached to the cooling tower 5 and in parallel with the trial operation. Therefore, since there is no need for an additional process for the surface treatment during the manufacturing of the packing 51, a manufacturing period and a manufacturing cost can be reduced. Additionally, since there is no need to perform work of removing the packing 51 during the maintenance for the surface treatment and then attaching the packing 51 again, the labor and cost of maintenance can also be reduced.

### Surface Treatment 2 of Packing

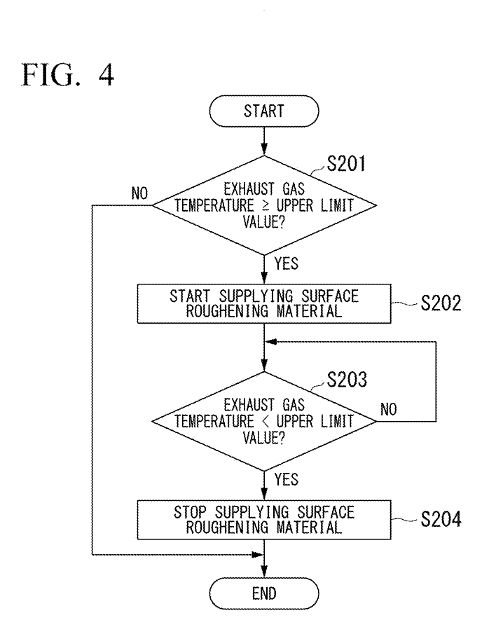

FIG. 4 is a second flowchart showing an example of the surface treatment according to the first embodiment of the present disclosure. Here, a method of performing the surface treatment of the packing 51 via the control unit 56 during the normal operation of the cooling tower 5 will be described. During the normal operation of the cooling tower 5, the control unit 56 keeps the control valve 542 of the supply unit 54 in a closed state and does not perform the surface treatment of the packing 51. However, the control unit 56 performs the surface treatment of the packing 51 in a case where the roughness of the surface of the packing 51 has decreased and the cooling capacity has diminished. Additionally, it is assumed that the circulation and supply of the cooling water by the circulation unit 52 and the liquid dispersing unit 53 (the same processing as in steps S102 and S103 in FIG. 3) are always performed during this period.

Specifically, the control unit 56 monitors the measured value of the temperature sensor 501 and determines whether the temperature of the exhaust gas G1 discharged from the cooling tower 5 is lower than an upper limit value (step S201). When the temperature of the exhaust gas G1 is lower than the upper limit value (step S201; NO), the control unit 56 determines that the cooling capacity of the packing 51 has not diminished, and ends the processing. On the other hand, when the temperature of the exhaust gas G1 is equal to or higher than the upper limit value (step S201; YES), the control unit 56 determines that the cooling capacity of the packing 51 has diminished. In this case, the control unit 56 performs control of bringing the control valve 542 of the supply unit 54 into an open state and starts supplying the powder M1 to the main body portion 50 (step S202). In this case, the control unit 56 controls the opening degree of the control valve 542 according to the flow rate of the exhaust gas G1, the material of the packing 51, and the like and adjusts the supply amount of the powder M1. Consequently, the packing 51 is roughened by the slurry obtained by mixing the powder M1 and the cooling water. Additionally, after the start of the supply of the powder M1, the powder M1 contained in the cooling water stored at the lower part of the main body portion 50 is filtered by the capture unit 55. The filtered cooling water not containing the powder M1 is drained from the branch flow passage 524, and the cooling water containing the powder M1 is returned to the circulation flow passage 521. The cooling water containing the powder M1, which has been returned to the circulation flow passage 521, is supplied to the main body portion 50 by the liquid dispersing unit 53 and is reused for roughening of the packing 51.

Next, the control unit 56 determines whether the temperature of the exhaust gas G1 discharged from the cooling tower 5 has decreased to below the upper limit value (step S203). When the temperature of the exhaust gas G1 is equal to or higher than the upper limit value (step S203; NO), the control unit 56 continues to supply the powder M1. On the other hand, when the temperature of the exhaust gas G1 is lower than the upper limit value (step S203; YES), the control unit 56 determines that the roughness of the surface of the packing 51 has been improved and the cooling capacity has been enhanced. In this case, the control unit 56 performs control of bringing the control valve 542 of the supply unit 54 into a closed state and stops supplying the powder M1 to the main body portion 50 (step 5204). After that, the cooling water and the powder M1 supplied to the main body portion 50 are discharged from the drainage flow passage 525 to the outside of the system when the control unit 56 opens the control valve 526.

The control unit 56 repeatedly performs the processing of FIG. 4 at each predetermined period during the normal operation of the cooling tower 5. In this manner, the control unit 56 can improve the roughness of the surface of the packing 51 and restore the cooling capacity without stopping the operation of the cooling tower 5 in a case where the roughness of the surface of the packing 51 has decreased and the cooling capacity has diminished. In addition, in a case where the roughness of the packing 51 is sufficiently high (the temperature of the exhaust gas can be maintained below the upper limit value), stopping the supply of the powder M1 can minimize the impact of wear of each unit (for example, the pump 522 and the like) of the cooling tower 5 caused by the powder M1 on damage or capacity degradation.

### Operation and Effect

As described above, the cooling tower 5 according to the present embodiment includes the packing 51 that cools the exhaust gas G1 flowing inside the cooling tower 5 (main body portion 50), the circulation unit 52 including the circulation flow passage 521 through which the cooling water stored in the lower part of the cooling tower 5 is pumped up by the pump 522 and circulated to the upper part of the cooling tower 5, and the heat exchanger 523 that cools the cooling water flowing through the circulation flow passage 521, the liquid dispersing unit 53 that is connected to the circulation flow passage 521 at the upper part of the cooling tower 5 and supplies the cooling water to the packing 51 from above the packing 51, and the supply unit 54 that supplies the surface roughening material (powder M1) for roughening the surface of the packing 51 to the inside of the cooling tower 5.

By having such a configuration, for example, after installing the cooling tower 5, performing the operation (the normal operation or the trial operation) of the cooling tower 5 while supplying the powder M1 makes it possible to perform the surface treatment to enhance the wettability by roughening the packing 51 in a state in which the packing 51 remains attached to the cooling tower 5. Therefore, since there is no need for an additional process for the surface treatment during the manufacturing of the packing 51, a manufacturing period and a manufacturing cost can be reduced. Additionally, since there is no need to perform work of removing the packing 51 during the maintenance for the surface treatment and then attaching the packing 51 again, the labor and cost of maintenance can also be reduced.

In addition, the cooling tower 5 further includes the control unit 56 that causes the supply unit 54 to supply the powder M1 to roughen the surface of the packing 51 before the normal operation of the cooling tower 5 and causes the supply unit 54 to stop supplying the powder M1 during the normal operation of the cooling tower 5.

In this manner, the cooling tower 5 can perform the surface treatment to roughen the packing 51 and enhance the wettability in parallel with the trial operation before the normal operation. Additionally, stopping the supply of the powder M1 during the normal operation can minimize the impact of the powder M1 on each unit (the pump 522 and the like) of the cooling tower 5.

In addition, the control unit 56 causes the supply unit 54 to supply the powder M1 in a case where the temperature of the exhaust gas G1 discharged from the cooling tower 5 (main body portion 50) is equal to or higher than the upper limit value during the normal operation of the cooling tower 5.

In this manner, the cooling tower 5 can improve the roughness of the surface of the packing 51, enhance the wettability, and restore the cooling capacity without stopping the operation of the cooling tower 5 in a case where the roughness of the surface of the packing 51 has decreased due to the cooling water washing away the packing 51 during the normal operation.

Additionally, the cooling tower 5 further includes the capture unit 55 that captures the powder M1 contained in the cooling water flowing through the circulation flow passage 521 and that is capable of re-adding the captured powder M1 to the circulation flow passage 521.

In this manner, the cooling tower 5 can return the powder M1 captured from the cooling water to the circulation flow passage 521 as necessary and reuse the powder M1 as the surface roughening material for roughening the packing 51.

Further, the surface roughening material is the powder M1 (soot) collected by the dust collection device 2 provided upstream of the cooling tower 5.

In this manner, the cooling tower 5 can perform the surface treatment to improve the roughness of the surface of the packing 51 by effectively using the soot collected by the dust collection device 2. As a result, there is no need to separately prepare the surface roughening material for the surface treatment of the packing 51, and the cost required for the surface treatment can be reduced.

In addition, the dust collection device 2 includes a plurality of dust collection units 21 that collect powders of different particle sizes, and the surface roughening material is the powder M1 collected by any one of the dust collection units 21 of the dust collection device 2.

In this manner, the cooling tower 5 can use a powder M1 of an appropriate particle size according to the material of the packing 51 and the like. As a result, the surface treatment of the packing 51 can be efficiently performed.

### Modification Example of First Embodiment

In the first embodiment, an example has been described in which the supply unit 54 includes the supply line 541 and the control valve 542 and the powder M1 collected by the dust collection device 2 is supplied to the main body portion 50 separately from the exhaust gas G1, but the present disclosure is not limited thereto. For example, in the present modification example, the dust collection device 2 functions as the supply unit 54. In this case, the supply line 541 and the control valve 542 may be omitted.

Additionally, in step S104 of FIG. 3 and step S202 of FIG. 4, the control unit 56 reduces the removal rate of the powder M1 of the dust collection device 2, which is the supply unit 54, and allows the powder M1 to flow into the main body portion 50 in a state in which the powder M1 is mixed with the exhaust gas G1. In a case where the dust collection device 2 is an electrostatic precipitator, the control unit 56 changes the removal rate of the powder M1 by, for example, performing charge control of the dust collection device 2. Further, in a case where the dust collection device 2 is a bag filter, the control unit 56 changes the removal rate of the powder M1 by changing, for example, the shaking-off operation or the like. The control unit 56 adjusts the amount (supply amount) of the powder M1 flowing into the main body portion 50 together with the exhaust gas G1 by changing the removal rate of the powder M1 in this manner. In this case, it is desirable that the control unit 56 adjusts the supply amount of the powder M1 such that the supply amount does not exceed the allowable range of the pump 522.

As described above, by using the dust collection device 2 as the supply unit 54 for the powder M1, a configuration for supplying the powder M1 (the supply line 541 and the control valve 542) can be omitted. As a result, the configuration of the cooling tower 5 can be made compact.

### Second Embodiment

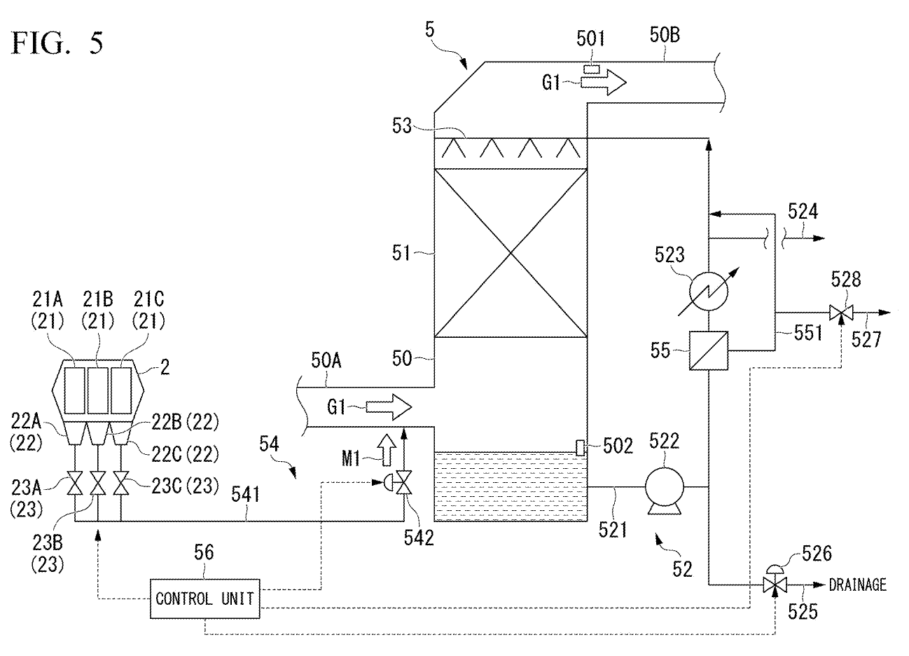

Next, a second embodiment will be described in detail with reference to FIG. 5. The same reference numerals are assigned to common components with the embodiment mentioned above, and detailed descriptions will be omitted.

FIG. 5 is a schematic diagram showing the configuration of a cooling tower according to the second embodiment of the present disclosure. As shown in FIG. 5, the capture unit 55 of the present embodiment is provided upstream of the heat exchanger 523 in the circulation flow passage 521. The capture unit 55 re-adds the captured powder M1 to the circulation flow passage 521 through a bypass flow passage 551 that connects the capture unit 55 and the circulation flow passage 521 on the downstream side of the heat exchanger 523.

In addition, in the present embodiment, the branch flow passage 524 (first drainage line), which discharges the filtered cooling water to the outside of the system, branches from the circulation flow passage 521 on the upstream side of a connection point between the circulation flow passage 521 and the bypass flow passage 551. Further, the bypass flow passage 551 is provided with a branch flow passage 527 (second drainage line) through which the cooling water containing the powder M1 captured by the capture unit 55 can be drained to the outside of the system.

In step S104 of FIG. 3 and step S202 of FIG. 4, while the powder M1 is being supplied under the control of the control unit 56, the powder M1 contained in the cooling water is filtered by the capture unit 55, and the filtered cooling water not containing the powder M1 is introduced into the heat exchanger 523 provided downstream of the capture unit 55. The cooling water containing the powder M1 captured by the capture unit 55 bypasses the heat exchanger 523 through the bypass flow passage 551 and is re- added to the circulation flow passage 521. Additionally, a plurality of filters (filter unit) are provided in the capture unit 55. The capture unit 55 can operate a backwashing function to remove the powder M1 adhering to each filter. In this case, the control unit 56 may close a valve 528 and re-add the powder M1 removed by the filter using the backwashing function to the circulation flow passage. Further, the control unit 56 may open the valve 528 provided in the branch flow passage 527 to discharge the powder M1 removed by the filter using the backwashing function to the outside of the system and reduce the amount of the powder M1 to be re-added to the circulation flow passage 521. The control unit 56 controls the opening and closing of the valve 528 by accepting, for example, an instruction from the operator. The capture unit 55 can operate the backwashing function on at least one of the group consisting of the plurality of filters while continuing to filter the cooling water with the other filter. That is, even while the capture unit 55 is washing a part of the filters, the filtered cooling water can always flow through the heat exchanger 523. In addition, in a case where the ratio of the surface roughening material to flow is to be increased, the valve (not shown) may be opened to drain the filtered cooling water from the branch flow passage 524. After the control unit 56 stops supplying the powder M1 in step S106 of FIG. 3 and step S204 of FIG. 4, the cooling water containing the powder M1 may be discharged from the drainage flow passage 525 to the outside of the system by opening the control valve 526. The cooling water containing the powder M1 may be discharged from the branch flow passage 527 to the outside of the system by opening the valve 528 instead of the drainage flow passage 525 and can also be discharged from both the drainage flow passage 525 and the branch flow passage 527. Although a configuration has been described as an example in which the plurality of filters are provided in the capture unit 55, the present disclosure is not limited to this configuration and can be changed as appropriate.

In this manner, since the cooling water passing through the heat exchanger 523 is cooling water from which the powder M1 has been removed, dirt (powder M1) adhering to the heat exchanger 523 can be suppressed.

### Third Embodiment

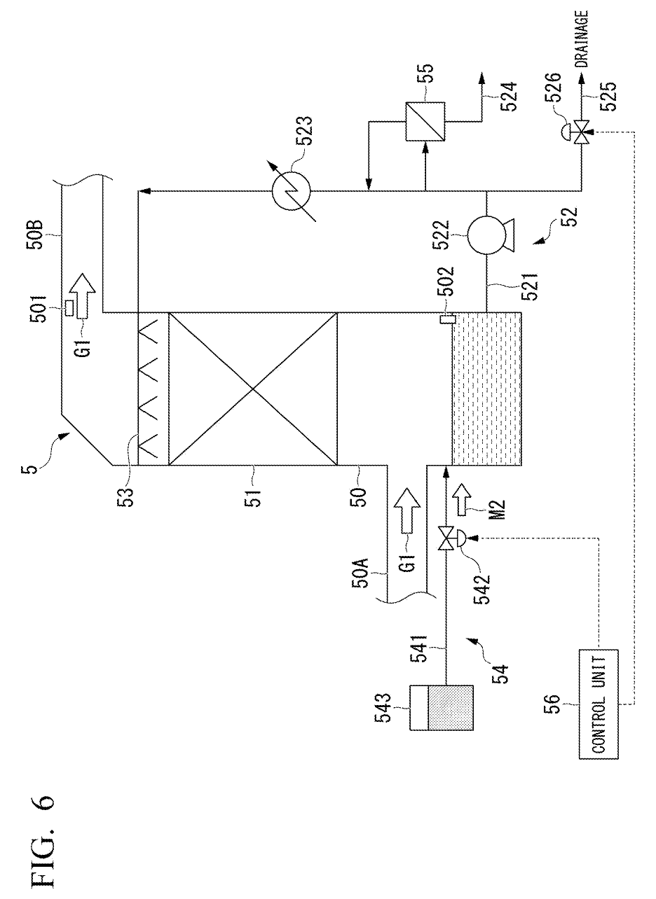

Next, a third embodiment will be described in detail with reference to FIG. 6. The same reference numerals are assigned to common components with the embodiment mentioned above, and detailed descriptions will be omitted.

FIG. 6 is a schematic diagram showing the configuration of a cooling tower according to the third embodiment of the present disclosure. As shown in FIG. 6, the supply unit 54 of the present embodiment further includes a slurry storage tank 543. Additionally, in the present embodiment, a slurry M2 stored in the slurry storage tank 543 is used as the surface roughening material. The slurry M2 is, for example, colloidal silica. The slurry M2 of any particle size may be purchased and used according to the material of the packing 51 and the like. As the slurry M2, the slurry (circulation water) of the desulfurization device 3 may be used.

As described above, by using the slurry M2 as the surface roughening material, handling properties such as replenishment can be improved as compared with the powder M1.

In a case where a commercially available slurry M2 is used, a slurry of an appropriate particle size can be selected in accordance with the material of the packing 51 and the like. As a result, the packing 51 can be effectively roughened to improve the wettability.

In FIG. 6, an example has been shown in which the configuration of the supply unit 54 of the first embodiment (FIG. 2) is replaced with the configuration of the supply unit 54 of the third embodiment and the slurry M2 is used as the surface roughening material, but the present disclosure is not limited thereto. In another embodiment, the configuration of the supply unit 54 of the second embodiment (FIG. 5) may be replaced with the configuration of the supply unit 54 of the third embodiment. That is, the configurations of the circulation unit 52 and the capture unit 55 of the second embodiment can also be applied to the third embodiment.

### Computer Configuration

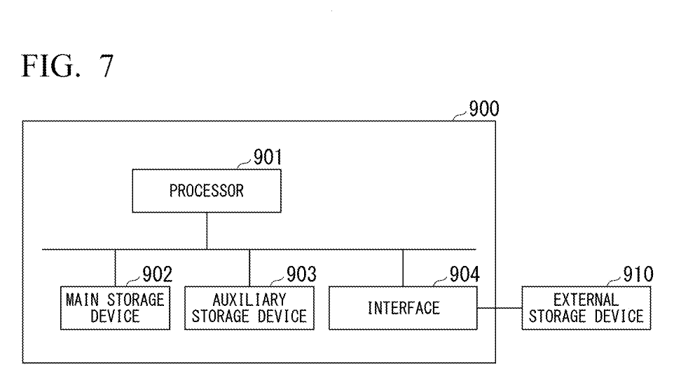

FIG. 7 is a schematic block diagram showing the configuration of a computer of the control unit according to at least one embodiment. A computer 900 includes a processor 901, a main storage device 902, an auxiliary storage device 903, and an interface 904.

The control unit 56 of the cooling tower 5 mentioned above is mounted in the computer 900. The operation of the control unit 56 mentioned above is stored in the auxiliary storage device 903 in a form of a program. The processor 901 reads the program from the auxiliary storage device 903, loads the program into the main storage device 902, and executes the above-described processing in accordance with the program. Additionally, the processor 901 secures a storage area corresponding to each of the storage units mentioned above in the main storage device 902 in accordance with the program. The program may be for implementing some of the functions to be exhibited by the computer 900. For example, the program may be for exhibiting the functions using a combination with other programs already stored in the auxiliary storage device 903 or a combination with other programs mounted in other devices. In another embodiment, the computer 900 may be provided with a custom large scale integrated circuit (LSI) such as a programmable logic device (PLD), in addition to the above-described configuration or instead of the above-described configuration. A programmable array logic (PAL), a generic array logic (GAL), a complex programmable logic device (CPLD), a field programmable gate array (FPGA), and the like are exemplary examples of the PLD. In this case, some or all of the functions implemented by the processor 901 may be implemented by the integrated circuit.

A hard disk drive (HDD), a solid state drive (SSD), a magnetic disk, a magneto- optical disk, a compact disc read only memory (CD-ROM), a digital versatile disc read only memory (DVD-ROM), a semiconductor memory, and the like are exemplary examples of the auxiliary storage device 903. The auxiliary storage device 903 may be an internal medium connected directly to the bus of the computer 900 or an external storage device 910 connected to the computer 900 via the interface 904 or a communication line. Additionally, in a case where this program is distributed to the computer 900 via the communication line, the computer 900, which has received the distribution, may load the program into the main storage device 902 and execute the above-described processing. In at least one embodiment, the auxiliary storage device 903 is a non-transitory tangible storage medium.

As described above, several embodiments related to the present disclosure have been described, but all of these embodiments are presented as examples and are not intended to limit the scope of the invention. These embodiments can be performed in various other forms, and various omissions, replacements, and changes can be made within the scope that does not depart from the gist of the invention. These embodiments and modifications thereof are included within the scope of the invention described in the claims and the scope of the equivalents thereof, as well as within the scope and the gist of the invention.

### Supplementary Note

The cooling tower, the carbon dioxide capture device, and the method for treating the surface of the packing, which are described in the above-mentioned embodiments, are understood as follows, for example.

(1) According to a first aspect, the cooling tower 5 that cools the exhaust gas G1 includes the packing 51 that cools the exhaust gas G1 flowing inside the cooling tower 5, the circulation unit 52 including the circulation flow passage 521 through which the cooling water stored in the lower part of the cooling tower 5 is pumped up by the pump 522 and circulated to the upper part of the cooling tower 5, and the heat exchanger 523 that cools the cooling water flowing through the circulation flow passage 521, the liquid dispersing unit 53 that is connected to the circulation flow passage 521 at the upper part of the cooling tower 5 and supplies the cooling water to the packing 51 from above the packing 51, and the supply unit 54 that supplies the surface roughening material M1, M2 for roughening the surface of the packing 51 to the inside of the cooling tower 5.

By having such a configuration, for example, after installing the cooling tower 5, performing the operation (the normal operation or the trial operation) of the cooling tower 5 while supplying the surface roughening material M1, M2 makes it possible to perform the surface treatment to enhance the wettability by roughening the packing 51 in a state in which the packing 51 remains attached to the cooling tower 5. Therefore, since there is no need for an additional process for the surface treatment during the manufacturing of the packing 51, a manufacturing period and a manufacturing cost can be reduced. Additionally, since there is no need to perform work of removing the packing 51 during the maintenance for the surface treatment and then attaching the packing 51 again, the labor and cost of maintenance can also be reduced.

(2) According to a second aspect, the cooling tower 5 according to the first aspect further includes the control unit 56 that controls the supply unit 54 to supply or stop supplying the surface roughening material M1, M2.

In this manner, the cooling tower 5 can start and stop supplying the surface roughening material M1, M2 as necessary.

(3) According to a third aspect, the cooling tower 5 according to the second aspect further includes the control unit 56 that causes the supply unit 54 to supply the surface roughening material M1, M2 to roughen the surface of the packing 51 before the normal operation of the cooling tower 5 and causes the supply unit 54 to stop supplying the surface roughening material M1, M2 during the normal operation of the cooling tower 5.

In this manner, the cooling tower 5 can perform the surface treatment to roughen the packing 51 and enhance the wettability in parallel with the trial operation before the normal operation. In addition, stopping the supply of the surface roughening material M1, M2 during the normal operation can minimize the impact of the surface roughening material M1, M2 on each unit (the pump 522 and the like) of the cooling tower 5.

(4) According to a fourth aspect, in the cooling tower 5 according to the second aspect, the control unit 56 causes the supply unit 54 to supply the surface roughening material M1, M2 in a case where the temperature of the exhaust gas G1 discharged from the cooling tower 5 is equal to or higher than the upper limit value during a normal operation of the cooling tower 5.

In this manner, the cooling tower 5 can improve the roughness of the surface of the packing 51, enhance the wettability, and restore the cooling capacity without stopping the operation of the cooling tower 5 in a case where the roughness of the surface of the packing 51 has decreased due to the cooling water washing away the packing 51 during the normal operation.

(5) According to a fifth aspect, in the cooling tower 5 according to the fourth aspect, the control unit causes the supply unit to stop supplying the surface roughening material in a case where the temperature of the exhaust gas discharged from the cooling tower is lower than the upper limit value.

In this manner, the cooling tower 5 can suppress the impact of the surface roughening material M1, M2 applied on each unit of the cooling tower 5 by stopping the supply of the surface roughening material M1, M2 in a case where the temperature of the exhaust gas G1 is lowered to below the upper limit value, that is, in a case where the wettability of the packing 51 is restored.

(6) According to a sixth aspect, the cooling tower 5 according to any one of the first to fifth aspects further includes a capture unit 55 that captures the surface roughening material M1, M2 contained in the cooling water flowing through the circulation flow passage 521 and that is capable of re-adding the captured surface roughening material M1, M2 to the circulation flow passage 521.

In this manner, the cooling tower 5 can return the surface roughening material M1, M2 captured from the cooling water to the circulation flow passage 521 as necessary and reuse the surface roughening material as the surface roughening material for roughening the packing 51.

(7) According to a seventh aspect, in the cooling tower 5 according to the fourth aspect, the control unit 56 discharges the surface roughening material M1, M2 captured by the capture unit 55 from the cooling water to the outside of the system during at least one of the group consisting of: when the surface roughening material M1, M2 is being supplied, or after the supply of the surface roughening material M1, M2 has been stopped.

In this manner, the cooling tower 5 can discharge the surface roughening material M1, M2 to the outside of the system such that the surface roughening material M1, M2 is not returned to the circulation flow passage 521 after the roughening of the packing 51 has been completed and the supply of the surface roughening material M1, M2 has been stopped. As a result, it is possible to suppress the impact of the surface roughening material M1, M2 applied on each unit of the cooling tower 5. Additionally, the cooling tower 5 can adjust the surface roughening material M1, M2 to be supplied to the packing 51 to prevent an excessive amount of the surface roughening material M1, M2 from being supplied, by discharging the cooling water containing the surface roughening material M1, M2 to the outside of the system when the surface roughening material M1, M2 is being supplied.

(8) According to an eighth aspect, the cooling tower 5 according to the seventh aspect further includes the drainage flow passage 525 through which the cooling water is configured to be discharged from the upstream side of the capture unit 55 in the circulation flow passage 521 to the outside of the system, the first drainage line 524 through which the cooling water filtered by the capture unit 55 is configured to be discharged to the outside of the system, and the second drainage line 527 through which the cooling water containing the surface roughening material M1, M2 captured by the capture unit 55 is configured to be discharged to the outside of the system, in which the control unit 56 adjusts the amount of the surface roughening material M1, M2 to be re- added to the circulation flow passage 521 by discharging the cooling water containing the surface roughening material M1, M2 from at least one of the group consisting of the drainage flow passage 525 or the second drainage line 527 to the outside of the system or by discharging the filtered cooling water from the first drainage line 524 to the outside of the system.

In this manner, the cooling tower 5 can drain the filtered cooling water not containing the surface roughening material M1, M2 and the cooling water containing the surface roughening material M1, M2 from separate lines. In addition, the cooling tower 5 can increase the amount of the surface roughening material M1, M2 to be re-added to the circulation flow passage 521 by draining the filtered cooling water and can decrease the amount of the surface roughening material M1, M2 to be re-added to the circulation flow passage 521 by draining the cooling water containing the surface roughening material M1, M2.

(9) According to a ninth aspect, in the cooling tower 5 according to any one of the sixth to eighth aspects, the capture unit 55 is provided upstream of the heat exchanger 523 in the circulation flow passage 521 and re-adds the captured surface roughening material M1, M2 to the circulation flow passage 521 through the bypass flow passage 551 that is connected to the circulation flow passage 521 while bypassing the heat exchanger 523.

In this manner, since the cooling water passing through the heat exchanger 523 is cooling water from which the surface roughening material M1, M2 has been removed, dirt (surface roughening material M1, M2) adhering to the heat exchanger 523 can be suppressed.

(10) According to a tenth aspect, in the cooling tower 5 according to any one of the first to ninth aspects, the surface roughening material is the powder M1 containing at least one of the group consisting of coal ash, limestone, mica, quartz, or silicon dioxide.

By employing the powder M1 corresponding to the material of the packing 51 as the surface roughening material, the packing 51 can be appropriately roughened.

(11) According to an eleventh aspect, in the cooling tower 5 according to any one of the first to ninth aspects, the surface roughening material is the powder M1 collected by the dust collection device 2 provided upstream of the cooling tower 5. In this manner, the cooling tower 5 can perform the surface treatment to improve the roughness of the surface of the packing 51 by effectively using the soot collected by the dust collection device 2. As a result, there is no need to separately prepare the surface roughening material for the surface treatment of the packing 51, and the cost required for the surface treatment can be reduced.

(12) According to a twelfth aspect, in the cooling tower 5 according to the eleventh aspect, the dust collection device 2 includes the plurality of dust collection units 21 that collect powders of different particle sizes, and the surface roughening material is the powder M1 collected by any one of the dust collection units 21 of the dust collection device 2.

In this manner, the cooling tower 5 can use a powder M1 of an appropriate particle size according to the material of the packing 51 and the like. As a result, the surface treatment of the packing 51 can be efficiently performed.

(13) According to a thirteenth aspect, in the cooling tower 5 according to any one of the first to ninth aspects, the supply unit 54 is the dust collection device 2 provided upstream of the cooling tower 5 and reduces the removal rate of the powder M1 contained in the exhaust gas G1 to supply the powder M1, which is the surface roughening material, to the inside of the cooling tower 5 together with the exhaust gas G1.

In this manner, the cooling tower 5 can perform the surface treatment to improve the roughness of the surface of the packing 51 by effectively using the soot collected by the dust collection device 2. Consequently, there is no need to separately prepare the surface roughening material for the surface treatment of the packing 51, and the cost required for the surface treatment can be reduced. Further, the cooling tower 5 can omit a configuration for supplying the powder M1 (the supply line 541 and the control valve 542). As a result, the configuration of the cooling tower 5 can be made compact.

(14) According to a fourteenth aspect, in the cooling tower 5 according to any one of the first to ninth aspects, the surface roughening material is the slurry M2.

As described above, by using the slurry M2 as the surface roughening material, handling properties such as replenishment can be improved as compared with the powder M1.

(15) According to a fifteenth aspect, in the cooling tower 5 according to the fourteenth aspect, the slurry M2 is circulation water of the desulfurization device 3 provided upstream of the cooling tower 5.

In this manner, by using the slurry inside the carbon dioxide capture system 100, it is possible to eliminate the need for a tank or the like for storing a purchased slurry and to save space in the cooling tower 5.

(16) According to a sixteenth aspect, the carbon dioxide capture device 4 includes the cooling tower 5 according to any one of the first to fourteenth aspects, the absorption tower 6 that absorbs carbon dioxide contained in the exhaust gas G1 cooled by the cooling tower 5 into an absorbent liquid for removal, and the regeneration tower 7 that regenerates the absorbent liquid by separating the carbon dioxide from the absorbent liquid discharged from the absorption tower 6.

(17) According to a seventeenth aspect, the method for treating the surface of the packing 51 of the cooling tower 5 that cools the exhaust gas G1 includes a step of cooling the exhaust gas G1 flowing inside the cooling tower 5, via the packing 51, a step of pumping up the cooling water stored in the lower part of the cooling tower 5 using the pump 522 and circulating the cooling water to the upper part of the cooling tower 5 through the circulation flow passage 521, and cooling the cooling water flowing through the circulation flow passage 521, via the heat exchanger 523, a step of supplying the cooling water to the packing 51 from above the packing 51, via the liquid dispersing unit 53 connected to the circulation flow passage 521 at the upper part of the cooling tower 5, and a step of supplying the surface roughening material M1, M2 for roughening the surface of the packing 51 to the inside of the cooling tower 5.

### Explanation of References

100: carbon dioxide capture system

2: dust collection device

21, 21A, 21B, 21C: dust collection unit

22, 22A, 22B, 22C: hopper

23, 23A, 23B, 23C: on-off valve

3: desulfurization device

4: carbon dioxide capture device

5: cooling tower

50: main body portion

50A: exhaust gas introduction flow passage

SOB: exhaust gas discharge flow passage

501: temperature sensor 502: liquid level sensor

51: packing

52: circulation unit

521: circulation flow passage

522: pump

523: heat exchanger

524: branch flow passage 525: drainage flow passage

526: control valve

53: liquid dispersing unit

54: supply unit 541: supply line 542: control valve

543: slurry storage tank

55: capture unit

551: bypass flow passage

552: control valve 56: control unit

6: absorption tower

7: regeneration tower

M1: powder (surface roughening material)

M2: slurry (surface roughening material)

What is claimed is:

1. A cooling tower that cools exihaust gas, comprising:a packing configured to cool the exhaust gas flowing inside the cooling tower;a circulation unit including a circulation flow passage through which cooling water stored in a lower part of the cooling tower is pumped up by a pump and circulated to an upper part of the cooling tower, and a heat exchanger configured to cool the cooling water flowing through the circulation flow passage;a liquid dispersing unit connected to the circulation flow passage at the upper
part of the cooling tower and configured to supply the cooling water to the packing from above the packing; and a supply unit configured to supply a surface roughening material for roughening a surface of the packing to the inside of the cooling tower.

2. The cooling tower according to claim 1, further comprising:a control unit configured to control the supply unit to supply or stop supplying the surface roughening material.

3. The cooling tower according to claim 2,
wherein the control unit causes the supply unit to supp ly the surface roughening material to roughen the surface of the packing before a normal operation of the cooling tower and causes the supply unit to stop supplying the surface roughening material during the normal operation of the cooling tower.

4. The cooling tower according to claim 2,
where the control unit causes the supply unit to supply the surface roughening material in a case where a temperature of the exhaust gas discharged from the cooling tower is equal to or higher than an upper limit value during a normal operation of the cooling tower.

5. The cooling tower according to claim 4,
wherein the control unit causes the supply unit to stop supplying the surface roughening material in a case where the temperature of the exhaust gas discharged from the cooling tower is lower than the upper limit value.

6. The cooling tower according to claim 2, further comprising:
a capture unit configured to filter the cooling water flowing through the circulation flow passage, capture the surface roughening material contained in the cooling water, and re-add the captured surface roughening material to the circulation flow passage.

7. The cooling tower according to claim 6,
wherein the control unit discharges the cooling water containing the surface roughening material to an outside of a system during at least one of the group consisting of: when the surface roughening material is being supplied, and after the supply of the surface roughening material has been stopped.

8. The cooling tower according to claim 7, further comprising:
a drainage flow passage through which the cooling water is configured to be discharged from an upstream side of the capture unit in the circulation flow passage to the outside of the system;
a first drainage line through which the cooling water filtered by the capture unit is configured to be discharged to the outside of the system; and
a second drainage line through which the cooling water containing the surface roughening material captured by the capture unit is configured to be discharged to the outside of the system,
wherein the control unit adjusts an amount of the surface roughening material to be re-added to the circulation flow passage by discharging the cooling water containing the surface roughening material from at least one of the group consisting of the drainageflow passage and the second drainage line to the outside of the system or by discharging the filtered cooling water from the first drainage line to the outside of the system.

9. The cooling tower according to claim 6,
wherein the capture unit is provided upstream of the heat exchanger in thecirculation flow passage and re-adds the captured surface rougheningmaterial to the circulation flow passage through a bypass flow passage that is connected to the circulation flow passage while bypassing the heat exchanger.

10. The cooling tower according to claim 1,
wherein the surface roughening material is a powder containing at least one of the group consisting of coal ash, limestone, mica, quartz, and silicon dioxide.

11. The cooling tower according to claim 1,
wherein the surface roughening material is a powder collected by a dustcollection device provided upstream of the cooling tower.

12. The cooling tower according to claim 11,
wherein the dust collection device includes a plurality of dust collection units configured to collect powders of different particle sizes, and
the surface roughening material is a powder collected by any one of the dust collection units of the dust collection device.

13. The cooling tower according to claim 1,
wherein the supply unit is a dust collection device provided upstream of thecooling tower and reduces a removal rate of a powder contained in the exhaust gas to supply the powder, which is the surface roughening material, to the inside of the cooling tower together with the exhaust gas.

14. The cooling tower according to claim 1,
wherein the surface roughening material is a slurry.

15. The cooling tower according to claim 14,
wherein the slurry is circulation water of a desulfurization device provided upstream of the cooling tower.

16. A carbon dioxide capture device comprising:
the cooling tower according to claim 1;
an absorption tower configured to absorb carbon dioxide contained in the exhaust gas cooled by the cooling tower into an absorbent liquid for removal; and
a regeneration tower configured to regenerate the absorbent liquid by separating the carbon dioxide from the absorbent liquid discharged from the absorption tower.

17. A method for treating a surface of a packing of a cooling tower that cools exhaust gas, the method comprising:
a step of cooling the exhaust gas flowing inside the cooling tower, via a packing;
a step of pumping up cooling water stored in a lower part of the cooling tower using a pump and circulating the cooling water to an upper part of the cooling tower through the circulation flow passage, and cooling the cooling water flowing through the circulation flow passage, via a heat exchanger;
a step of supplying the cooling water to the packing from above the packing, via a liquid dispersing unit connected to the circulation flow passage at the upper part of the cooling tower; and
a step of supplying a surface roughening material for roughening a surface of the packing to the inside of the cooling tower.
